(19) United States
(12) Patent Application Publication
(10) Pub. No.: US 2018/0102550 A1
(43) Pub. Date: Apr. 12, 2018

(54) ELECTRODES FOR SELECTIVE VAPOR-PHASE ELECTROCHEMICAL REACTIONS IN AQUEOUS ELECTROCHEMICAL CELLS

(71) Applicant: Board of Trustees of the University of Arkansas, Little Rock, AR (US)

(72) Inventors: Robert Henry Coridan, Fayetteville, AR (US); Hamed Mehrabi, Tehran (IR)

(21) Appl. No.: 15/730,529

(22) Filed: Oct. 11, 2017

Related U.S. Application Data
(60) Provisional application No. 62/406,975, filed on Oct. 12, 2016.

(51) Int. Cl. H01M 4/86; H01M 4/88; H01M 8/0239; H01M 8/04089; H01M 8/04291

(52) U.S. Cl. CPC H01M 4/8605; H01M 4/8867; H01M 8/04291; H01M 8/04089; H01M 8/0239

(57) ABSTRACT

The invention generally relates to electrodes for selective vapor-phase electrochemical reactions in aqueous environments, and more particularly to a structured electrode having an electrocatalyst layer covered by a porous, hydrophobic polymer layer for control of liquid-phase and gas-phase reactions in aqueous environments. The porous, hydrophobic polymer layer supports an evolved gas bubble or plastron layer over the electrocatalyst layer to ensure the interface is preferentially accessible to gas-phase or highly volatile reactants. A membrane-free electrolyzer or electrochemical system can be built using the hydrophobic structured electrodes, separating the gases as they are evolved and before they are mixed or dissolved in any significant quantity.

### CROSS REFERENCE TO RELATED APPLICATIONS

The application claims the benefit of and priority to U.S. Provisional Patent Application No. 62/406,975, filed Oct. 12, 2016, and incorporates by reference said provisional application in its entirety.

### BACKGROUND OF THE INVENTION

### 1. Field of the Invention

This invention relates generally to electrodes for selective vapor-phase electrochemical reactions in aqueous environments.

### 2. Description of the Related Art

Converting gas-phase reactants like carbon dioxide (CO₂), nitrogen gas (N₂), or methane (CH₄) to more desirable chemicals generally requires high-temperature, high-pressure chemical reactors. An electrochemical approach is attractive alternative because it provides for direct conversion of reactants to desired products, improved efficiency through electrochemistry rather than thermochemistry, and the ability to tune parameters of the catalyst to promote product specificity. Unfortunately, the prospect of adapting promising chemical catalysts to electrochemical reactions is complicated at best. Gas-phase electrochemistry suffers from poor conductivity and mass transport between the working and counter electrodes, resulting in highly inefficient processes carried out at high biases. Liquid-phase reactions are limited by poor gas-phase reactant solubility, allowing the intended process to be dominated by unwanted reactions with the electrolyte or corrosive processes on the catalyst itself.

Moreover, work on electrode structures has generally dealt with liquid-phase or fuel cell applications, while others have utilized hydrophobic pillars patterned with catalyst or homogeneous mixtures. These generally have involved blended, homogeneous hydrophobic structures or patterned structures involving alternating hydrophobic and hydrophilic regions. Gas-phase electrolytic reactors require high pressure and the application of impractically large bias potentials to drive electrocatalysis. Liquid-phase electrochemical cells dramatically improve conductivity, but low gas solubility and competing electrolytic processes make catalysis of gas-phase reactants difficult in liquid cells.

A distributed system based on a coupled photovoltaic array and electrolyzer system is the current state-of-the-art approach to storing solar energy in chemical bonds (artificial photosynthesis). Considering all of the costs that go into an electrolyzer system, the separation and crossover prevention are a significant fraction of the cost. By some estimates, the membrane assembly and flow/separator systems used to manage the products of electrolysis are estimated to be about 72% of the cost of the electrolysis stack, or about 36% of the total capital costs of a commercial electrolyzer. Moreover, the conductivity of the ion exchange membrane (selectively transporting protons produced in the anode compartment to balance proton consumption in the cathode compartment) is one of the largest contributors to efficiency loss in the system and the main consideration for durability in the electrolysis stack. The membrane is an important consideration of the electrolyzer, as it prevents oxygen/hydrogen crossover (mixtures of oxygen and hydrogen are flammable at 4% hydrogen in air) and provides mechanical stability for the differential pressures generated by non-stoichiometric gas evolution (2 mol hydrogen per mol oxygen) in the two compartments. Gas separation and collection from solution adds further efficiency losses due to the added input power required for operation.

Plastron structures, superhydrophobic polymer structures supporting a vapor layer, have been studied over the last ten (10) years by other groups to understand the fundamental physics of wetting while controlling the surface tension and to consider the potential for superlubricating gas layers; however, no prior plastron structures have been configured for catalysis or configured to control the gas-liquid-solid three phase boundary during electrocatalysis of vapor phase reactants and/or products.

There are many patents that either focus on the synthesis for superhydrophobic interfaces or use the “lotus effect”/“salvinia effect”/“superhydrophobic interfaces” to make self-cleaning surfaces. The lotus effect describes a superhydrophobic interface induced by hierarchically structured fibrous microstructure, which are typically used for self-cleaning surfaces, windows, etc. where small volumes of water are rapidly repelled from the surface, taking any dirt along with it. In some cases, inorganic photocatalysts are included in the design in order to take advantage of sunlight; however, these are generally not used for underwater applications due to the electrode surface not being designed to maintain superhydrophobicity under the hydrostatic pressures of submergence.

For example, U.S. Patent Publication No. 2015/0129431 discloses the design and manufacture of a hydrophobic, gas-permeable electrode. U.S. Pat. No. 5,702,839 discloses a fuel cell electrode with a catalyst selected for gas-phase reactions below a patterned layer of a hydrophobic polymer. U.S. Pat. No. 8,367,266 discloses an electrochemical electrode with catalyst particles blended directly into a porous hydrophobic polymer, rather than a porous layer above a layer of catalyst. U.S. Pat. No. 4,581,116 discloses a layered electrode containing a porous hydrophobic layer above a hydrophilic catalyst layer. Korean Patent No. KR20080025433 discloses a porous, hydrophobic layer for an electrode in an aqueous cell to prevent water from contacting the electrode. German Patent No. TW201213616 discloses an electrode for electrochemical cells that has a porous, hydrophobic coating over a catalyst, and Japanese Patent No. JPS62207893 an unstructured hydrophobic electrode to improve durability and performance using a blended mixture of catalyst, conductor, and polymer.

It is therefore desirable to provide electrodes for selective vapor-phase electrochemical reactions in aqueous environments.

It is further desirable to provide a hierarchically-structured electrode having selective catalytic activity in order to perform selective, specific electrochemical reactions while minimizing the formation of undesired byproducts.

It is still further desirable to provide a hierarchically-structured electrode that is highly efficient and lowers operating costs for electrochemical processes.

It is yet further desirable to provide a layered electrode for aqueous electrochemical cells with a structured, hydrophobic surface providing high selectivity and improved Faradaic/current efficiency for reducing or eliminating undesirable, competing reactions.

It is still yet further desirable to provide an electrode having mixed metal and hydrophobic surfaces for control of the gas-liquid-solid three phase boundary during electrocatalysis of vapor phase reactants and/or products.

It is still further desirable to provide a lithographically-patterned, plastron supporting electrode specifically targeted at controlling liquid-phase (hydrogen evolution, water oxidation) and volatile-molecule gas phase (methanol oxidation) reactions.

It is still further desirable to provide a plastron-supporting hydrophobic surface over electrocatalytic metal layers to inhibit electrochemical reactions with the electrolyte, such as hydrogen evolution and water oxidation, while being able to perform other redox reactions.

It is still yet desirable to provide a plastron-supporting electrode for use in industrial and lab-scale chemical processes as a selected, longer-life electrode, which may be tuned to a variety of reactions depending on the catalyst used.

Before proceeding to a detailed description of the invention, however, it should be noted and remembered that the description of the invention which follows, together with the accompanying drawings, should not be construed as limiting the invention to the examples (or embodiments) shown and described. This is so because those skilled in the art to which the invention pertains will be able to devise other forms of this invention within the ambit of the appended claims.

### SUMMARY OF THE INVENTION

In general, in a first aspect, the invention relates to a structured, layered electrode configured for vapor-phase electrochemical reactions in aqueous environments. The electrode has a hydrophobic or superhydrophobic polymer layer partially covering a metal electrocatalyst layer. A substrate, such as a silicon wafer, supports the electrocatalyst layer and the polymer layer. The hydrophobic polymer layer includes a plurality of support pores or prepared with desirable porosity configured to support a thin gas layer over the electrocatalyst layer.

The support pores or porosity can have any characteristic size that supports a plastron layer, which is generally observed to be in pores less than 100 micrometers. The vapor-phase electrochemical reactions include, but are not limited to, methane oxidation, methanol oxidation, carbon dioxide reduction, nitrogen fixation, or a combination thereof. The electrocatalyst layer may be constructed from, but not limited to, metal, metal oxide, or molecular electrocatalyst layers on a conductive layer. The polymer layer may be constructed from, but not limited to, a photopatternable polymer such as SU-8, hydrophobic organic polymers such as polystyrene or poly-methyl methacrylate (PMMA), a silicon-based organic polymer such as polydimethylsiloxane (PDMS), or a fluorinated polymer such as polytetrafluoroethylene (PTFE). In addition, the electrode can also include a network of hydrophobic or superhydrophobic channels in fluid communication with the support pores. The channels are positioned in the polymer layer adjacent to the electrocatalyst layer, and can be in fluid communication with a pump or other addressable method(s) of inducing gas flow.

In general, in a second aspect, the invention relates to a water electrolyzer incorporating the structured, layered electrode described above.

In general, in a third aspect, the invention relates to a membrane-free electrochemical system. The membrane-free electrochemical cell has a counter electrode and a working electrode with a metallic electrocatalyst layer covering a substrate. The electrocatalyst layer is at least partially covered by a porous, hydrophobic or superhydrophobic polymer layer that does not necessarily support a plastron layer. The polymer layer has a plurality of plastron support pores or desirable porosity configured to control evolving gas bubbles from the electrocatalyst layer. The polymer layer also has a plurality of hydrophobic or superhydrophobic channels in fluid communication with the support pores. The substrate can be constructed from a silicon wafer, and the electrocatalyst a metal, metal oxide, molecular electrocatalyst or other material with desirable electrolytic properties. The polymer layer may be constructed from, but not limited to, photopatternable polymers such as SU-8, hydrophobic organic polymers such as polystyrene or poly-methyl methacrylate (PMMA), silicon-based organic polymers such as polydimethylsiloxane (PDMS), or fluorinated polymers such as polytetrafluoroethylene (PTFE). In addition, the electrode can also include a network of hydrophobic or superhydrophobic channels in fluid communication with the support pores. The channels are positioned in the polymer layer adjacent to the electrocatalyst layer, and can be in fluid communication with a pump for inducing a gas flow.

In general, in a fourth aspect, the invention relates to a method of manufacturing a layered, structured electrode configured for liquid-phase and gas-phase reactions in aqueous environments. The method includes any method to synthesize a polymer, polymer-based, or otherwise hydrophobic coating that partially covers a layer of electrocatalytically active material. An example of this method includes depositing an electrocatalyst layer on a substrate, and then coating the electrocatalyst layer with a photolithographically-patterned, plastron-supporting layer constructed from a porous, hydrophobic or superhydrophobic polymer layer. A plurality of plastron support pores or a desired porosity is formed in the polymer layer, and each of the support pores is configured to support a gas-liquid interface over the electrocatalyst layer, preventing liquid contact to the electrocatalyst layer. The method can further include forming a plurality of hydrophobic or superhydrophobic channels in fluid communication with the support pores in the polymer layer.

The foregoing has outlined in broad terms some of the more important features of the invention disclosed herein so that the detailed description that follows may be more clearly understood, and so that the contribution of the instant inventors to the art may be better appreciated. The invention is not to be limited in its application to the details of the construction and to the arrangements of the components set forth in the following description or illustrated in the drawings. Rather, the invention is capable of other embodiments and of being practiced and carried out in various other ways not specifically enumerated herein. Finally, it should be understood that the phraseology and terminology employed herein are for the purpose of description and should not be regarded as limiting, unless the specification specifically so limits the invention.

### BRIEF DESCRIPTION OF THE DRAWINGS

These and further aspects of the invention are described in detail in the following examples and accompanying drawings.

FIG. 1 is a schematic of an example of a structured electrode in accordance with an illustrative embodiment of the invention disclosed herein;

FIG. 2 is an SEM image of an example of a synthesized structured electrode in accordance with an illustrative embodiment of the invention disclosed herein;

FIG. 3A graphically illustrates electrochemical measurements on the structured electrodes disclosed herein demonstrating electrolytic currents due to reactions with solvent are eliminated;

FIG. 3B graphically illustrates selective reactions with volatile reactants facilitated on a structured electrode disclosed herein;

FIG. 4A is a schematic of another example of a structured electrode in accordance with an illustrative embodiment of the invention disclosed herein; and

FIG. 4B is a schematic of the structured electrode shown in FIG. 4A with an evolved gas bubble within a plastron support pore in accordance with an illustrative embodiment of the invention disclosed herein.

### DETAILED DESCRIPTION OF THE INVENTION

While this invention is susceptible of embodiment in many different forms, there is shown in the drawings, and will herein be described hereinafter in detail, some specific embodiments of the instant invention. It should be understood, however, that the present disclosure is to be considered an exemplification of the principles of the invention and is not intended to limit the invention to the specific embodiments so described.

The invention generally relates to electrodes for selective vapor-phase electrochemical reactions in aqueous environments, and more particularly to a structured electrode having an electrocatalyst layer covered by a porous, superhydrophobic layer for control of the gas-liquid-solid three phase boundary during electrocatalysis of vapor-phase reactants and/or products. The structured, layered electrode controls liquid-phase (hydrogen evolution, water oxidation) reactions and volatile-molecule gas-phase (methanol oxidation) reactions in aqueous environments.

The structured, layered electrode disclosed herein increases the selectivity of the electrochemical transformation of gaseous reactants in aqueous-phase chemical reactors by adopting a superhydrophobic polymer/metal interface motif. A gas layer on the structured, layered electrode is stable in submerged settings, thereby enabling selective catalysis of gas-phase reactions in aqueous environments. The structured, layered electrode achieves the benefits of both gas-phase electrochemical reactors (e.g., selectivity, reduced corrosion or other chemical transformation of catalysts, etc.) and liquid-phase chemical reactors (e.g., high conductivity, well-controlled and efficient chemical reactions, high rates, facile separations of gas-to-gas-phase products).

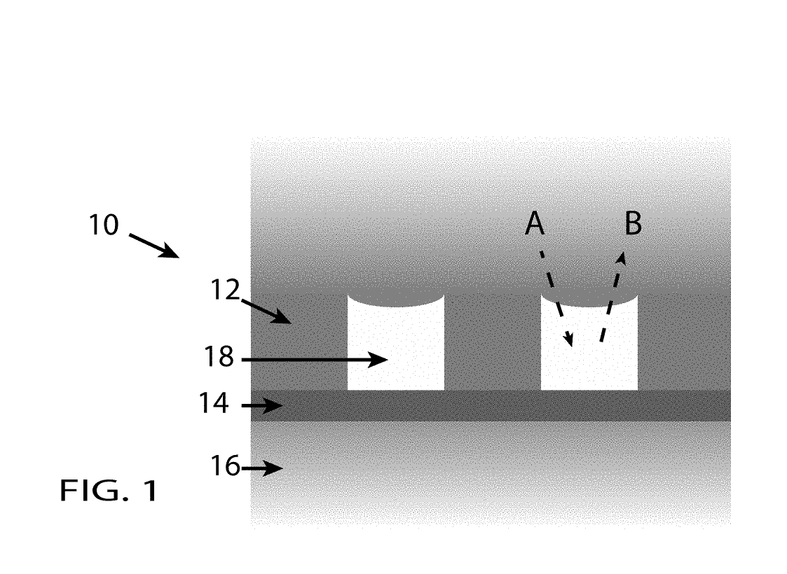

Referring to the figures of the drawings, wherein like numerals of reference designate like elements throughout the several views, the structured electrode 10 for selective vapor-phase electrochemical reactions in aqueous environments has a hydrophobic or superhydrophobic polymer layer 12 covering an electrocatalyst layer 14. The polymer layer 12 and the electrocatalyst layer 14 layer are supported by a substrate 16. The polymer layer 12 is porous having a plurality of plastron support pores 18 that support a thin gas layer (a “plastron layer”) 20 over the electrocatalyst layer 14 to ensure the interface is preferentially accessible to gas-phase or highly volatile reactants. The plastron layer 20 that is supported in the pores 18 of the polymer layer 12 over the electrocatalyst layer 14 inhibits electrochemical reactions with an electrolyte 22, such as hydrogen evolution and water oxidation, while being able to perform other redox reactions. As can be seen in FIG. 1, the net flux of reactants in the aqueous environment flow into the support pores 18 (arrow A), and the resulting gaseous or volatile products of the gas layer 20 are released (arrow B) for collection.

The substrate can be constructed from a silicon wafer, and the electrocatalyst a desired metal, metal oxide, molecular electrocatalyst or other electrocatalytically active material with desirable electrolytic properties. The appropriate electrocatalyst material is selected for the electrochemical reaction of interest. The polymer layer may be constructed from, but not limited to, photopatternable polymers such as SU-8, hydrophobic organic polymers such as polystyrene or poly-methyl methacrylate (PMMA), silicon-based organic polymer such as polydimethylsiloxane (PDMS), or fluorinated polymers such as polytetrafluoroethylene (PTFE).

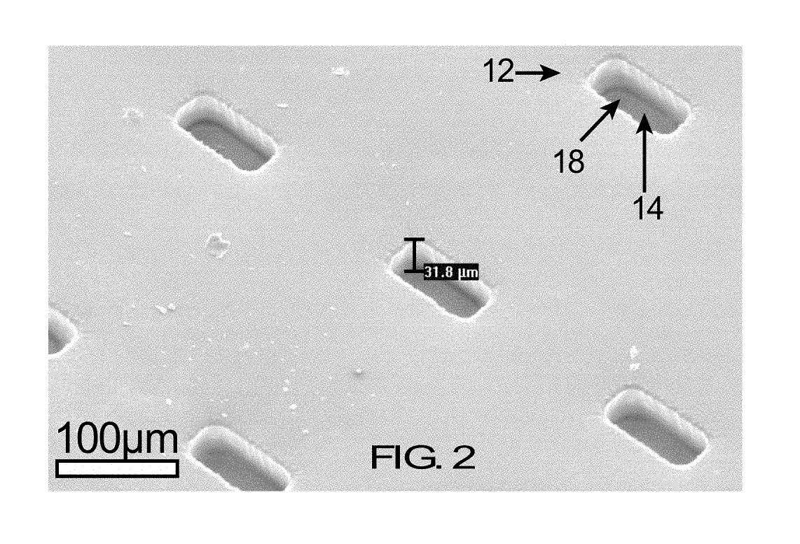

As shown in FIG. 2, to synthesize the structured electrode 10, an evaporated layer of electrocatalytically active material 14 is deposited on a suitable substrate 16, and then a photolithographically-patterned, hydrophobic polymer layer 12 is coated over the electrocatalyst layer 14. This synthesizing method results in a hydrophobic structured electrode 10 that can maintain the gas plastron layer 20 underwater. In addition to the foregoing described method, any method to synthesize a polymer, polymer-based, or otherwise hydrophobic coating that partially covers a layer of electrocatalytically active material can be used.

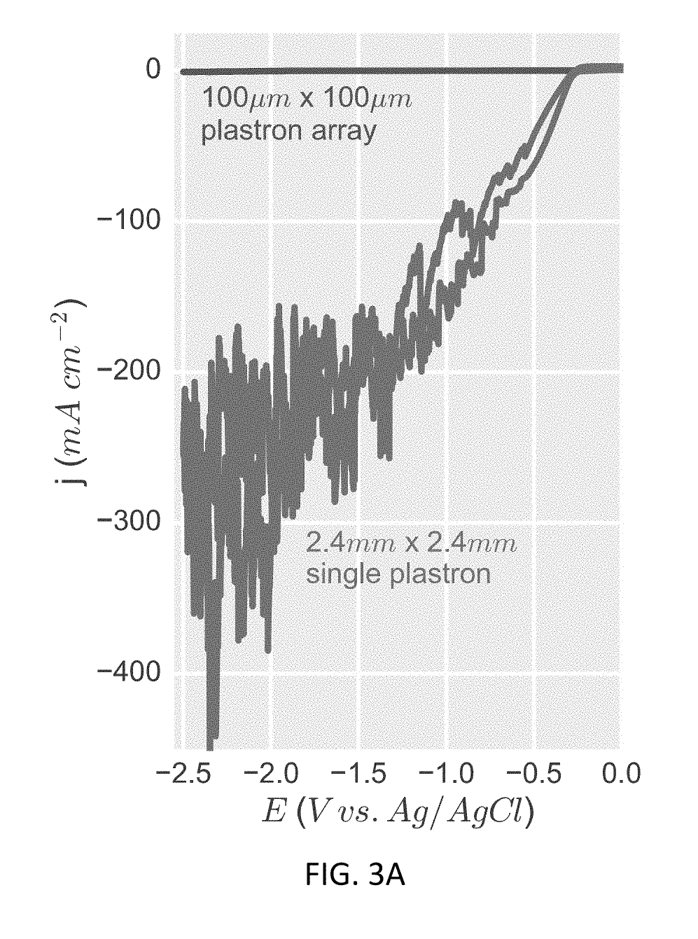

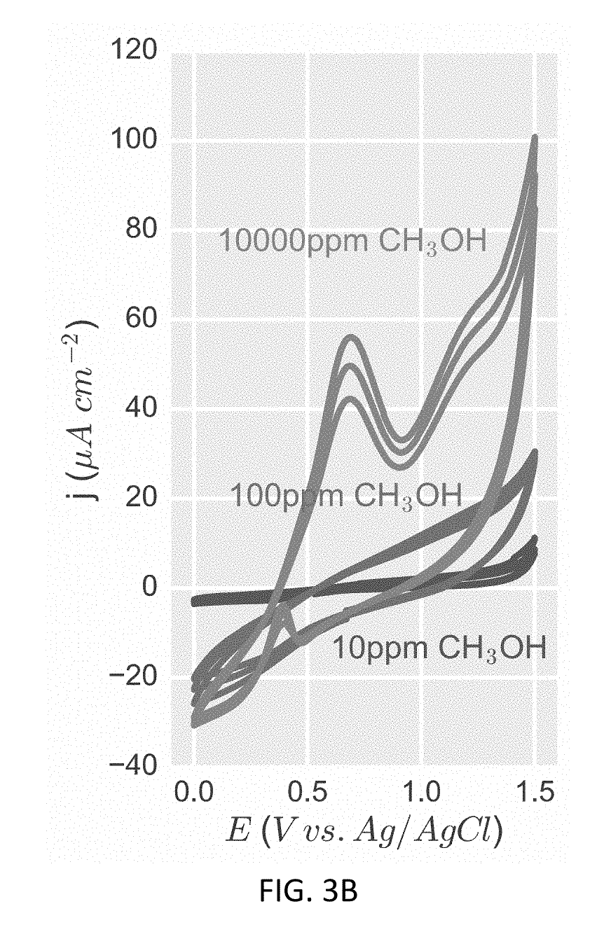

As demonstrated in FIGS. 3A and 3B, the hydrophobic structured electrode 10 dramatically suppresses hydrogen evolution and water oxidation on evaporated Pt electrocatalytic layers in sulfuric acid. FIG. 3A shows a clear difference between the hydrophobic structured electrode (red trace) and a PDMS coated electrode with a hole exposing roughly the same active catalytic surface area (blue trace). The area-normalized hydrogen evolution currents are negligible compared to those for virtually the same active surface area. This demonstrates the ability of the plastron layer to suppress highly-active reactions with the electrolyte solvent. As demonstrated in FIG. 3B, a volatile sacrificial oxidant, namely methanol was added, which has a large vapor pressure compared to water, and therefore acts as a simple reactant in the plastron vapor. A greater than 1000% increase was observed in oxidation current as well as characteristic Pt oxidation peaks in the cyclic voltammetry scans as the concentration of methanol was increased in the electrolyte. These results demonstrate that the structured electrode can selectively target reactions involving gas-phase reactants in aqueous electrochemical environments.

The structured electrode is highly selective, thereby potentially increasing selectivity and lowering operating costs for devices designed to operate the electrochemical processes. The inventive electrode has selective catalytic activity that reduces formation of undesired byproducts, and may be used in a variety of industrial and lab-scale electrochemical processes as a selected, longer-life electrode, which may be tuned to a variety of reactions depending on the catalyst used. In addition, the electrode provides high selectivity and improved Faradaic/current efficiency for reducing or eliminating undesirable, competing reactions within an electrochemical cell.

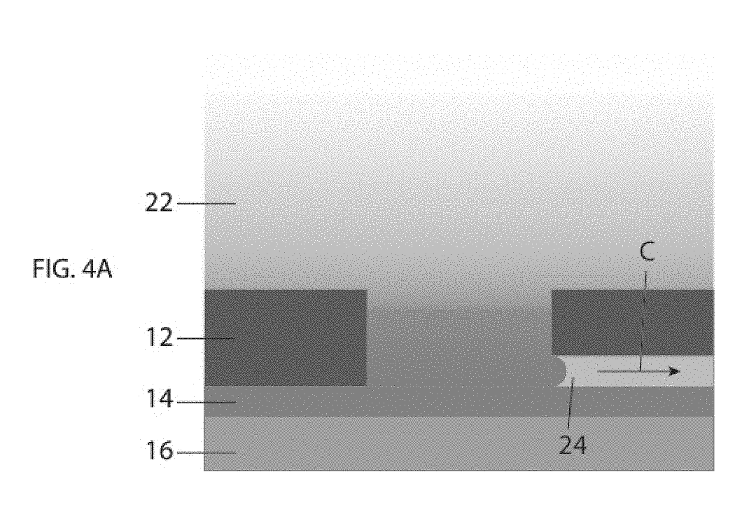

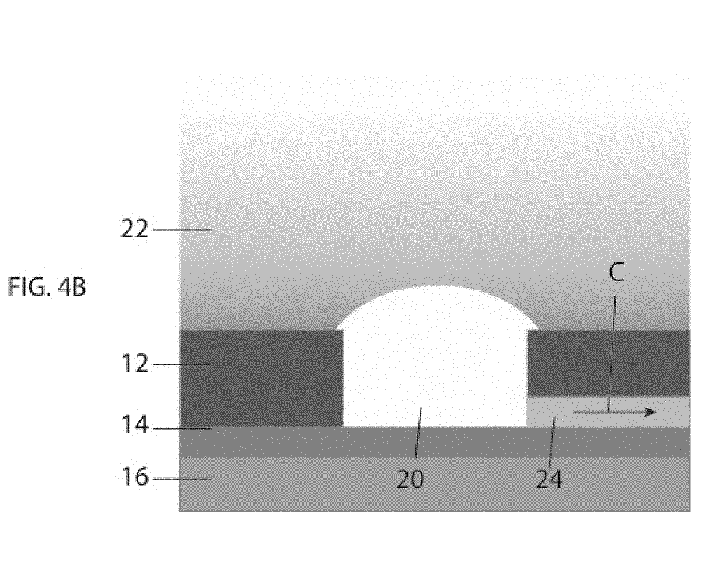

Referring now to FIGS. 4A and 4B, another application of the structured electrode disclosed herein is the separation of gas-phase products in aqueous electrochemical cells. Similar to the structured electrode 10 illustrated in FIG. 1, the structured electrode 10 exemplified in FIGS. 4A and 4B include the porous, hydrophobic or superhydrophobic polymer layer 12 covering the electrocatalyst metal layer 14. The polymer layer 12 and the electrocatalyst layer 14 layer are supported by the substrate 16. The polymer layer 12 includes the plurality of plastron support pores 18 that support the gas plastron layer 20 over the electrocatalyst layer 14. A network of hydrophobic gas channels 24 are in fluid communication with the plastron support pores 18, and the channels 24 are formed in the polymer layer 12 adjacent to the electrocatalyst layer 14.

During operation, a current is passed through the electrocatalyst layer 14 causing an evolved gas bubble plastron layer 20 to form on the structured electrode 10. The plastron support pore 18 is able to hold the gas bubble plastron layer 20 until the plastron layer 20 contacts the gas channel 24. A differential pressure generated by a pump, gas flow, or other the like (not shown) may be used to draw the evolved gas plastron bubble layer 20 out of the plastron support pore 18 along flow path A to be collected, and restores the electrocatalyst layer 14 and electrolyte 22 contact as shown in FIG. 4A for further evolution reactions.

A membrane-free electrolyzer or electrochemical cell can be built based on two hydrophobic structured electrodes—one structured electrode 10 optimized for the hydrogen evolution reaction (polymer layer 12 with plastron support pores 18 and hydrophobic channels 24 covering the optimized electrocatalyst layer 14) and the other structured electrode 10 for the water oxidation reaction. This structured electrode 10 construct does not to block the electrolyte 22 from contacting the electrocatalyst layer 14, but retains the evolved gas bubble 20 within the support pore 18 long enough that plastron layer 20 can be wicked away along channel 24. The structured electrode 10 is configured to allow the electrolyte 22 to contact and wet the electrocatalyst layer 14, and the electrolytically evolved gas bubbles of the plastron layer 20 can be mechanically controlled. Rather than be released from the electrode 10 as a detaching bubble, the plurality hydrophobic channels 24 in fluid communication with the plurality of plastron support pores 18 can be attached to the pump (e.g., a Venturi pump flowing a clean stream of the collected gas) to draw out the evolved gas of the plastron layer 20 and restore the electrolyte 22/electrocatalyst layer 14 contact for further evolution reactions.

The membrane-free electrolyzer/electrochemical system can be built in parallel, separating the gases as they are evolved and before they are mixed or dissolved in any significant quantity. The passive separating flow system along the hydrophobic channels 24 avoids the need for storage tanks or separation membrane, dramatically reducing the potential costs of the system. Moreover, gases lost to dissolution are limited by their relative solubility (˜40 mg/L for O₂, 0.16 mg/L for H₂) and dissolved gases are not a flammability risk.

For example, the plastron support pores 18 in the polymer layer 12 and the connecting network of hydrophobic channels 24 between the polymer layer 12 and the electrocatalyst layer 14 provide a method to separate the oxygen and hydrogen directly after water electrolysis. In an acidic solution (e.g., 1M H₂SO₄) or an alkaline solution (e.g., 1M KOH), a metal cathode reduces protons to molecular hydrogen while the anode oxidizes water to oxygen. The overall evolution reaction (molecular water split to hydrogen and oxygen) is an endergonic, energy storing reaction, and the resulting hydrogen can be recombined with oxygen in a fuel cell to generate electricity on demand or combined with carbon monoxide to form syngas, an industrial feedstock.

The membrane-free electrolyzer can be fabricated by casting the polymer layer 12 (e.g., PDMS films) in lithographically produced or machined templates. The templating structure would be the inverse structure of the structured electrodes 10 (pillars for plastron support pores 18 and long groves to template the network of hydrophobic channels 24). The polymer layer 12 should be sufficiently hydrophobic to support the gas-phase in the channels 24. The cast polymer layer 12 can be attached to an electrocatalyst layer 14 and supported by a substrate 16 to form the hybrid structured electrode 10 disclosed herein. More scalable approaches can be prepared as a roller template to pattern square-meter scale hydrophobic plastron support pores and channels or potentially three-dimensional, hierarchically structured heterogeneous electrodes.

It is to be understood that the terms “including”, “comprising”, “consisting” and grammatical variants thereof do not preclude the addition of one or more components, features, steps, or integers or groups thereof and that the terms are to be construed as specifying components, features, steps or integers.

If the specification or claims refer to “an additional” element, that does not preclude there being more than one of the additional element.

It is to be understood that where the claims or specification refer to “a” or “an” element, such reference is not to be construed that there is only one of that element.

It is to be understood that where the specification states that a component, feature, structure, or characteristic “may”, “might”, “can” or “could” be included, that particular component, feature, structure, or characteristic is not required to be included.

It is to be understood that were the specification or claims refer to relative terms, such as “front,” “rear,” “lower,” “upper,” “horizontal,” “vertical,” “above,” “below,” “up,” “down,” “top,” “bottom,” “left,” and “right” as well as derivatives thereof (e.g., “horizontally,” “downwardly,” “upwardly” etc.), such reference is used for the sake of clarity and not as terms of limitation, and should be construed to refer to the orientation as then described or as shown in the drawings under discussion. These relative terms are for convenience of description and do not require that the apparatus be constructed or the method to be operated in a particular orientation. Terms, such as “connected,” “connecting,” “attached,” “attaching,” “join” and “joining” are used interchangeably and refer to one structure or surface being secured to another structure or surface or integrally fabricated in one piece.

Where applicable, although state diagrams, flow diagrams or both may be used to describe embodiments, the invention is not limited to those diagrams or to the corresponding descriptions. For example, flow need not move through each illustrated box or state, or in exactly the same order as illustrated and described.

Methods of the instant disclosure may be implemented by performing or completing manually, automatically, or a combination thereof, selected steps or tasks.

The term “method” may refer to manners, means, techniques and procedures for accomplishing a given task including, but not limited to, those manners, means, techniques and procedures either known to, or readily developed from known manners, means, techniques and procedures by practitioners of the art to which the invention belongs.

For purposes of the instant disclosure, the term “at least” followed by a number is used herein to denote the start of a range beginning with that number (which may be a ranger having an upper limit or no upper limit, depending on the variable being defined). For example, “at least 1” means 1 or more than 1. The term “at most” followed by a number is used herein to denote the end of a range ending with that number (which may be a range having 1 or 0 as its lower limit, or a range having no lower limit, depending upon the variable being defined). For example, “at most 4” means 4 or less than 4, and “at most 40%” means 40% or less than 40%. Terms of approximation (e.g., “about”, “substantially”, “approximately”, etc.) should be interpreted according to their ordinary and customary meanings as used in the associated art unless indicated otherwise. Absent a specific definition and absent ordinary and customary usage in the associated art, such terms should be interpreted to be ±10% of the base value.

When, in this document, a range is given as “(a first number) to (a second number)” or “(a first number)-(a second number)”, this means a range whose lower limit is the first number and whose upper limit is the second number. For example, 25 to 100 should be interpreted to mean a range whose lower limit is 25 and whose upper limit is 100. Additionally, it should be noted that where a range is given, every possible subrange or interval within that range is also specifically intended unless the context indicates to the contrary. For example, if the specification indicates a range of 25 to 100 such range is also intended to include subranges such as 26-100, 27-100, etc., 25-99, 25-98, etc., as well as any other possible combination of lower and upper values within the stated range, e.g., 33-47, 60-97, 41-45, 28-96, etc. Note that integer range values have been used in this paragraph for purposes of illustration only and decimal and fractional values (e.g., 46.7-91.3) should also be understood to be intended as possible subrange endpoints unless specifically excluded.

It should be noted that where reference is made herein to a method comprising two or more defined steps, the defined steps can be carried out in any order or simultaneously (except where context excludes that possibility), and the method can also include one or more other steps which are carried out before any of the defined steps, between two of the defined steps, or after all of the defined steps (except where context excludes that possibility).

Still further, additional aspects of the instant invention may be found in one or more appendices attached hereto and/or filed herewith, the disclosures of which are incorporated herein by reference as if fully set out at this point.

Thus, the present invention is well adapted to carry out the objects and attain the ends and advantages mentioned above as well as those inherent therein. While the inventive concept has been described and illustrated herein by reference to certain illustrative embodiments in relation to the drawings attached thereto, various changes and further modifications, apart from those shown or suggested herein, may be made therein by those of ordinary skill in the art, without departing from the spirit of the inventive concept the scope of which is to be determined by the following claims.

What is claimed is:

1. A structured, layered electrode configured for vapor-phase electrochemical reactions in aqueous environments, said electrode comprising:
a porous, hydrophobic or superhydrophobic polymer layer partially covering a electrocatalyst layer of electrocatalytically active material;
a substrate supporting said electrocatalyst layer and said polymer layer;
said polymer layer having a predetermined porosity configured to support a thin gas layer over said electrocatalyst layer.

2. The electrode of claim 1 wherein said pores of said polymer layer have a diameter of less than approximately one-hundred (100) microns.

3. The electrode of claim 1 wherein said vapor-phase electrochemical reactions in aqueous environments comprise nitrogen fixation, methane oxidation, methanol oxidation, carbon dioxide reduction, or a combination thereof.

4. The electrode of claim 1 wherein said substrate comprises a silicon wafer.

5. The electrode of claim 1 wherein said electrocatalyst layer comprises a layer of an electrocatalytically active material, and wherein said electrocatalytically active material comprises a metal, a metal oxide, a molecular catalyst or a combination thereof.

6. The electrode of claim 1 wherein said polymer layer comprises a photopatternable polymer, a hydrophobic organic polymer, a silicon-based organic polymer, a fluorinated polymer, or a combination thereof.

7. The electrode of claim 6 wherein said photopatternable polymer comprises SU-8, wherein said hydrophobic organic polymer comprises polystyrene or poly-methyl methacrylate (PMMA), wherein said silicon-based organic polymer comprises polydimethylsiloxane (PDMS), wherein said fluorinated polymers comprises polytetrafluoroethylene (PTFE), or a combination thereof.

8. A water electrolyzer comprising the electrode of claim 1.

9. The electrolyzer of claim 8 further comprising a plurality of hydrophobic or superhydrophobic channels in fluid communication with said porous, hydrophobic polymer layer.

10. The electrolyzer of claim 9 wherein said channels are formed in said porous, hydrophobic polymer layer adjacent to said electrocatalyst layer.

11. The electrolyzer of claim 9 further comprising a pump in fluid communication with said channels.

12. A membrane-free electrochemical system, comprising:
a working electrode comprising a metallic electrocatalyst layer covering a substrate; said electrocatalyst layer covered by a porous, hydrophobic or superhydrophobic polymer layer; said polymer layer having a plurality of plastron support pores having a porosity configured to support a gas-liquid interface over said electrocatalyst layer; said polymer layer having a plurality of hydrophobic or superhydrophobic channels in fluid communication with said support pores; and
a counter electrode.

13. The electrochemical system of claim 12 wherein said substrate comprises a silicon wafer.

14. The electrochemical system of claim 12 wherein said electrocatalyst layer comprises a metal, a metal oxide, a molecular catalyst or a combination thereof.

15. The electrochemical system of claim 12 wherein said polymer layer comprises a photopatternable polymer, a hydrophobic organic polymer, a silicon-based organic polymer, a fluorinated polymer, or a combination thereof.

16. The electrochemical system of claim 15 wherein said photopatternable polymer comprises SU-8, wherein said hydrophobic organic polymer comprises polystyrene or poly-methyl methacrylate (PMMA), wherein said silicon-based organic polymer comprises polydimethylsiloxane (PDMS), wherein said fluorinated polymers comprises polytetrafluoroethylene (PTFE), or a combination thereof.

17. The electrochemical system of claim 12 wherein said channels are formed in said polymer layer adjacent to said electrocatalyst layer.

18. The electrochemical system of claim 17 wherein said channels are in fluid communication with a pump.

19. A method of manufacturing a layered, structured electrode configured for liquid-phase and gas-phase reactions in aqueous environments, said method comprising the steps of:
depositing a electrocatalyst layer of electrocatalytically active material on a substrate;
then, coating said electrocatalyst layer with a hydrophobic or superhydrophobic polymer or polymer-based layer; and
forming a plurality of plastron support pores or a desirable porosity in said polymer layer configured to control evolving gas bubbles from said electrocatalyst layer and to prevent liquid contact with said electrocatalyst layer.

20. The method of claim 19 further comprising the step of forming a plurality of hydrophobic or superhydrophobic channels in fluid communication with said support pores in said polymer layer.
